(19) United States
(12) Patent Application Publication
(10) Pub. No.: US 2008/0244015 A1
(43) Pub. Date: Oct. 2, 2008

(54) APPARATUS, SYSTEM, AND METHOD FOR AUTOMATED DIALOG DRIVEN UP-SELLING

(76) Inventors: Michael Terrell Vanover, Raleigh, NC (US); James J. Thrasher, Efland, NC (US)

Correspondence Address: Kunzler & McKenzie, 8 EAST BROADWAY, SUITE 600, SALT LAKE CITY, UT, 84111, US

(21) Appl. No.: 11/695,496

(22) Filed: Apr. 2, 2007

(51) Int. Cl. G06F 15/16

(52) U.S. Cl. 709/206

(57) ABSTRACT

An apparatus, system, and method are disclosed for automated dialog driven up-selling. A conversion module may convert a service dialog into service dialog text. A search module searches the service dialog text from the service dialog between a customer and a customer service agent for at least one specified key word. An identification module identifies a customer interaction in response to the at least one key word. An opportunity module identifies an interaction opportunity wherein the customer is not interacting with the customer service agent. A presentation module presents the customer interaction to a customer. A blocking module may receive a blocking request and block customer interaction.

### BACKGROUND OF THE INVENTION

1. Field of the Invention

This invention relates to up-selling and more particularly relates to automated dialog driven up-selling.

2. Description of the Related Art

Customers often employ customer services such as on-line help web interfaces, call center help desks, and the like. For example, a customer may have a problem with a personal computer (PC). The customer may go to a web page that aids the customer in diagnosing the problem. In addition, the customer may communicate with a customer service agent regarding the problem, such as through a Voice Over Internet Protocol (VOIP) audio connection or through Instant Messaging. Alternatively, the customer may make a telephone call to a call center help desk and discuss the problem with the customer service agent.

The customer and customer service agent typically discuss the customer's problems or other service needs. The discussion between the customer and customer service agent is referred to herein as a customer service dialog. During the customer service dialog, the customer may be placed on hold for one or more time intervals while the customer service agent accesses information, performs a service, and the like. These breaks in the customer service dialog are referred to herein as dialog pauses.

A dialog pause presents a unique opportunity to communicate to the customer products or services that may be useful to the customer. Continuing the example above, a dialog pause while the customer service agent helps the customer with a failed hard-disk drive may be an excellent opportunity to introduce the customer to external hard-disk drives that may be used to back-up PC data.

Unfortunately, the customer service agent is not always able to take advantage of such opportunities as the agent's first priority is typically to take care of the customer's immediate problem. As a result, many opportunities for introducing needed products and services are lost.

### SUMMARY OF THE INVENTION

From the foregoing discussion, there is a need for an apparatus, system, and method that automates dialog driven up-selling. Beneficially, such an apparatus, system, and method would inform customers of relevant products and increase sales for service providers.

The present invention has been developed in response to the present state of the art, and in particular, in response to the problems and needs in the art that have not yet been fully solved by currently available methods for automating dialog driven up-selling. Accordingly, the present invention has been developed to provide an apparatus, system, and method for automating dialog driven up-selling that overcome many or all of the above-discussed shortcomings in the art.

The apparatus to automate dialog driven up-selling is provided with a plurality of modules configured to functionally execute the steps of searching for key words, identifying interaction from key words, identifying interaction opportunities, and presenting interaction. These modules in the described embodiments include a search module, an identification module, an opportunity module, and a presentation module. The apparatus may also include a conversion module and a blocking module.

The conversion module may convert audio service dialog of a service dialog into service dialog text or it may use native text if instant messaging is the means of communication. The search module searches for at least one specified key word or phrase from the service dialog text. The service dialog is between a customer and a customer service agent. The identification module identifies a customer interaction in response to the key words. The opportunity module identifies an interaction opportunity, wherein the customer is not interacting with the customer service agent. The presentation module presents the customer interaction to a customer. In one embodiment, the blocking module receives a blocking request and blocks the customer interaction in response to the blocking request. The apparatus automates up-selling during service dialogs.

A system of the present invention is also presented to automate dialog driven up-selling. The system may be embodied in a data processing system. In particular, the system, in one embodiment, includes a communications medium and a computer. The communications medium provides communications between a customer and a customer service agent. The computer is in communication with the communications medium and includes a search module, an identification module, an opportunity module, a presentation module, and a blocking module.

The search module searches service dialog text from a service dialog between the customer and the customer service agent for at least one specified key word or phrase. The identification module identifies a customer interaction in response to the at least one key word. The opportunity module identifies an interaction opportunity wherein the customer is not interacting with the customer service agent. The presentation module configured to present the customer interaction to a customer.

The computer may further include a conversion module. The conversion module may convert the service dialog into the service dialog text. The blocking module receives a blocking request and blocks the customer interaction in response to the blocking request. The system automates dialog driven up-selling, presenting goods or services that meet customer needs.

A method of the present invention is also presented for automating dialog driven up-selling. The method in the disclosed embodiments substantially includes the steps to carry out the functions presented above with respect to the operation of the described apparatus and system. In one embodiment, the method includes searching a service dialog, identifying a customer interaction, identifying an interaction opportunity, and presenting the customer interaction. The method also may include converting the service dialog to text and blocking the customer interaction.

A conversion module may convert a service dialog into service dialog text. A search module searches the service dialog text from the service dialog between a customer and a customer service agent for at least one specified key word. An identification module identifies a customer interaction in response to the at least one key word. An opportunity module identifies an interaction opportunity wherein the customer is not interacting with the customer service agent. A presentation module presents the customer interaction to a customer. A blocking module may receive a blocking request and block customer interaction. The method automates dialog driven up-selling, presenting goods or services that improve sales.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention automates up-selling of products and services that are identified from a service dialog. In addition, the present invention may present a customer interaction without interfering with the service dialog. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a communication system in accordance with the present invention;

FIG. 2 is a schematic block diagram illustrating one embodiment of a computer of the present invention;

FIG. 3 is a schematic block diagram illustrating one embodiment of an up-selling apparatus of the present invention;

FIG. 4 is a schematic flow chart diagram illustrating one embodiment of an automated dialog driven up-selling method of the present invention;

FIGS. 5A and 5B are text representations illustrating one embodiment of service dialog text of the present invention;

FIG. 6 is a drawing illustrating one embodiment of a customer interaction of the present invention;

FIG. 7 is a drawing illustrating one embodiment of an Instant Messaging application of the present invention; and

FIG. 8 is a drawing illustrating one embodiment of a VOIP application of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays (FPGAs), programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within the modules, and may be embodied in any suitable form and organized within any suitable type of data structure. The operational data may be collected as a single data set, or may be distributed over different locations including different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

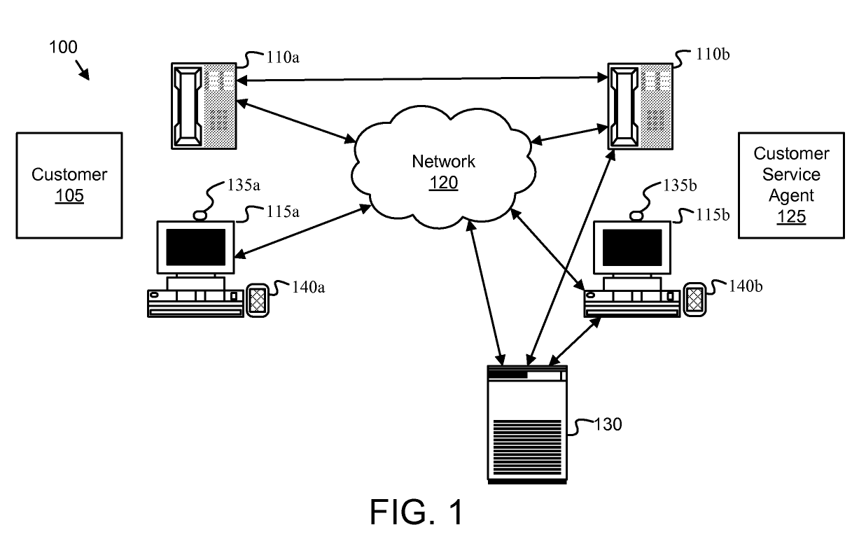

FIG. 1 is a schematic block diagram illustrating one embodiment of a communication system 100 in accordance with the present invention. The communication system 100 includes a customer 105, one or more phones 110, one or more computers 115, a network 120, a customer service representative 125, a server 130, one or more microphones 135, and one or more speakers 140. One skill of the art will also readily recognize that the communication system 100 could include other communication and data processing devices.

In an embodiment, the communication system 100 provides a customer service interaction for the customer 105. For example the customer 105 may access the customer service agent 125 by communicating a request through the network 120 using Voice Over Internet Protocol (VOIP) using the computer 115a, the microphone 135a and the speaker 140a. The customer service agent 125 using the computer 115b and the microphone 135b receives the VOIP request through the speaker 140b to diagnose the problem.

In an embodiment the communication system 100 provides an opportunity for up-selling to the customer 105. For example, the customer 105 may access the customer service agent 125 by the phone 110a to report a hard-drive failure. The customer service agent 125 using the phone 110b has a dialog to diagnose the problem.

In an alternate embodiment, the customer 105 may access the customer service agent 125 by communicating a request using the computer 115a in an on-line text chat from a chat service dialog through the network 120 and the server 130 to report a speaker failure problem. The customer service agent 125 using the computer 115b receives the on-line text chat request to diagnose the problem.

In a certain embodiment, the customer 105 may communicate with the customer agent 125 by communicating the request using an Instant Messaging program executing on the computer 115a. The customer service agent 125 may carry on a text-based service dialog with the customer 105 using the Instant Messaging program through the computer 115b.

The interaction with the customer service agent 125 may provide opportunities to provide additional goods and/or services that the customer 105 may need or want. Identifying key words in the dialog may establish which services the customer 105 may be most willing to purchase as will be described hereafter.

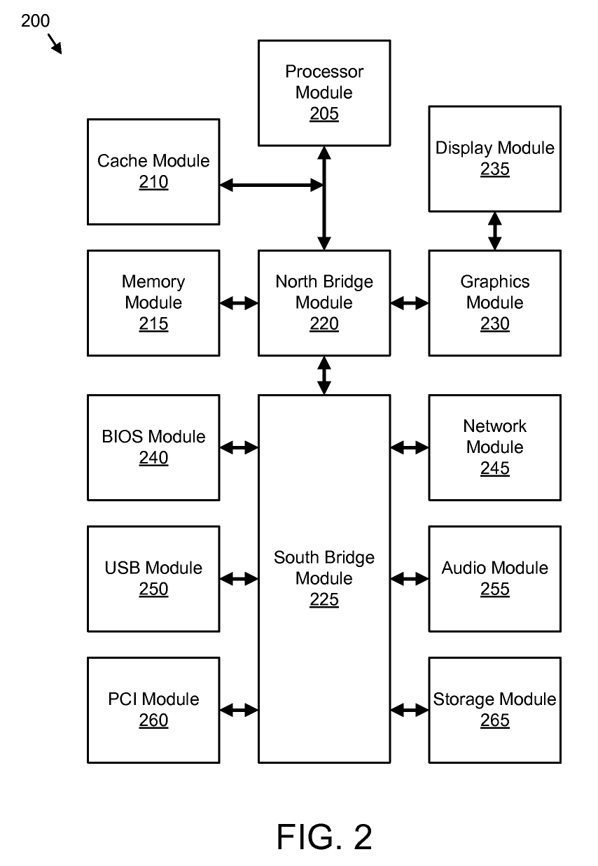

FIG. 2 depicts a schematic block diagram illustrating one embodiment of a computer 200 in accordance with the present invention. The computer 200 may be the server 130 and/or computers 115 of FIG. 1. The computer 200 has a processor module 205, a cache module 210, a memory module 215, a north bridge module 220, a south bridge module 225, a graphics module 230, a display module 235, a BIOS module 240, a network module 245, a USB module 250, an audio module 255, a PCI module 260, and a storage module 265.

Although for simplicity, one processor module 205, one cache module 210, one memory module 215, one north bridge module 220, one south bridge module 225, one graphics module 230, one display module 235, one BIOS module 240, one network module 245, one USB module 250, one audio module 255, one PCI module 260, one storage module 265 are shown, any number of processor modules 205, cache modules 210, memory modules 215, north bridge modules 220, south bridge modules 225, graphics modules 230, display modules 235, BIOS modules 240, network modules 245, USB modules 250, audio modules 255, PCI modules 260, storage modules 265 may be employed.

The processor module 205, cache module 210, memory module 215, north bridge module 220, south bridge module 225, graphics module 230, display module 235, BIOS module 240, network module 245, USB module 250, audio module 255, PCI module 260, and storage module 265, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory module 215 stores software instructions and data comprising computer program products. The processor module 205 executes one or more computer program products. The computer program products may be tangibly stored in the storage module 265. The storage module 265 may be a hard-disk drive, an optical storage device, a holographic storage device, a micromechanical storage device, a semiconductor storage device, or the like.

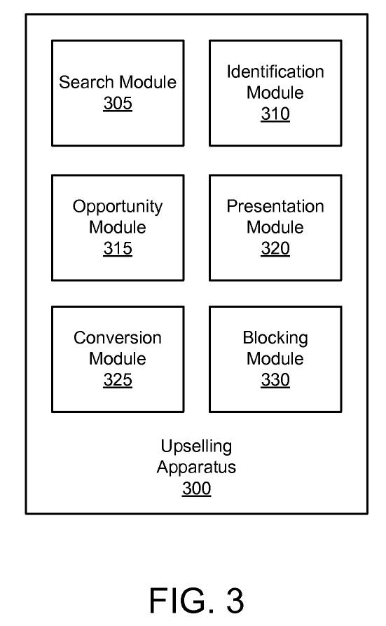

FIG. 3 is a schematic block diagram illustrating one embodiment of an up-selling apparatus 300 of the present invention. The apparatus 300 automates dialog driven up-selling and can be embodied in the computer 200 of FIG. 2. The description of apparatus 300 refers to elements of FIGS. 1-2, like numbers referring to like elements. The apparatus 300 includes a search module 305, an identification module 310, an opportunity module 315, a presentation module 320, a conversion module 325, and a blocking module 330. The search module 305, identification module 310, opportunity module 315, presentation module 320, conversion module 325, and blocking module 330 may each be configured as one or more computer program products executing on the computer 200.

The search module 305 searches a service dialog for key words. For example, the search module may search a service dialog text for key words that have been established to provide upselling opportunities. The service dialog may be an on-line text chat, a phone conversation and/or a VOIP conversation between the customer 105 and the customer service agent 125.

The identification module 310 identifies a customer interaction in response to the key words as will be described hereafter. The opportunity module 315 identifies an interaction opportunity, wherein the customer 105 is not interacting with the customer service agent 125. For example, the opportunity module 315 may measure time lapses that suggest a dialog pause to introduce up-selling. In another example, the opportunity module 315 may identify key words like “putting you on hold,” that will identify a dialog pause and up-selling opportunities.

The presentation module 320 presents a customer interaction to a customer. The customer interaction may be an up-selling message. For example, in the case of a hard-drive failure, the presentation module 320 may present a message on purchasing an external hard-drive to back-up information.

In one embodiment, the conversion module 325 converts an audio service dialog of the service dialog into the service dialog text. For example, a dialog in VOIP may be converted to text allowing the search module to search for key words. In another example, the conversion module 325 may convert a phone dialog to a service dialog text.

In one embodiment, the blocking module 330 receives a blocking request and blocks the customer interaction in response to the blocking request. For example, the customer 105 may choose to not hear up-selling messages and be given the opportunity to block them. In another example, the customer service agent 125 may block up-selling messages.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and the symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

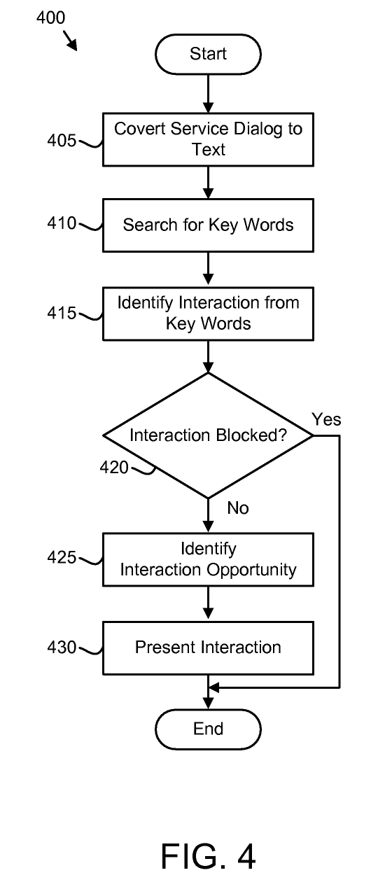

FIG. 4 depicts a schematic flow chart diagram illustrating one embodiment of an automated dialog driven up-selling method 400. The method 400 substantially includes the steps to carry out the functions presented above with respect to the operation of the described apparatus 300 and system 100 of FIGS. 3 and 1 respectively. The description of method 400 refers to elements of FIGS. 1-3, like numbers referring to like elements. In one embodiment, the method 400 is implemented with a computer program product comprising a computer readable medium having a computer readable program. The computer readable program may be executed by the computer 200.

The method 400 begins, and in an embodiment, the conversion module 325 converts 405 the service dialog to the service dialog text. The service dialog may be an audio service dialog between the customer 105 and the customer service agent 125 using a phone 110, and/or a computer 115 utilizing VOIP. Alternatively, the service dialog may be a chat service dialog between the customer 105 and the customer service agent 125 using a computer 115. For example, the conversion module 325 may convert 405 a service dialog of a VOIP request for data retrieval from a failed hard-drive into searchable text using a voice-recognition algorithm. In a certain embodiment, the voice-recognition algorithm may be trained during the audio service dialog to recognize the speech of the customer 105 by prompting the customer to verbally respond to one or more questions with one of a limited set of answers. The voice-recognition algorithm may identify the one or more answers, and adjust one or more parameters to target the customer's voice and speech patterns.

The search module 305 searches 410 for key words. For example, the search module 305 may search 410 for a key word “hard-drive”. In one embodiment, the search module 305 compares each word of the service dialog text to a list of key words. Each word of the service dialog text that corresponds to a word in the key word list may be flagged. Alternatively, each word of the service dialog text that corresponds to a word in the key word list may be written to a scratch file.

The identification module 310 identifies 415 a customer interaction from key words. For example, the identification module 310 may identify 415 a customer interaction from a key word “hard-drive” that may drive up-selling opportunities for an external hard-drive back-up.

In one embodiment, each key word is assigned a weight value. The identification module 310 may select a key word with the greatest weight value as a first node in a search tree. The identification module 310 may then select a branch of the search tree corresponding to a key word with the next greatest weight value. The identification module 310 may continue to traverse the search tree until a customer interaction is identified 415. The customer interaction may be associated with an end node of the search tree. Alternatively, a customer interaction may be associated with each node of the search and be selected if the search of the search tree ends with that node.

In an alternate embodiment, each customer interaction is associated with one or more key words. The key words from the service dialog text are statistically compared with customer interaction key words and a score is calculated for each customer interaction. The identification module 310 may identify 415 the customer interaction with the highest score.

In one embodiment, the blocking module 330 determines 420 if interactions are blocked. For example, an interaction opportunity may be presented to the customer 105 to receive a dialog driven up-selling presentation. The customer 105 may select to not receive the presentation, blocking interaction opportunities. In an alternate embodiment, the customer 105 may request the customer service agent 125 to block dialog driven up-selling presentations. In addition, the customer 105 may select an account option that blocks customer interactions. If the blocking module 330 determines 420 that the interaction is blocked from receiving dialog driven up-selling presentations, automated customer interactions will not be presented and the method 400 terminates.

If the blocking module 330 determines 420 that the customer interaction is not blocked, the opportunity module 315 will identify 425 an interaction opportunity. For example, if the blocking module 330 determines 420 that the interaction is not blocked, the opportunity module 315 will identify 425 an interaction opportunity by finding a dialog pause when the customer 105 is not interacting with the customer service agent 125. In an alternate embodiment, the opportunity module 315 may 425 identify an interaction opportunity by recognizing a key word that may predict an approaching opportunity.

In one embodiment, the opportunity module 315 receives a message that the customer 105 has been placed on hold. For example, the customer 105 may communicate with the customer service agent 125 using the communication system 100, so that the communication system 100 recognizes that the customer service agent 125 places the customer 105 on hold. If the customer service agent 125 is communicating with the customer 105 using VOIP through a second computer 115b, the second computer 115b may recognize when the customer service agent 125 places the customer 105 on hold.

In an alternate embodiment, the customer service agent 125 may communicate a message to the opportunity module 315 indicating that there an interaction opportunity is starting. For example, the customer service agent 125 may realize that the customer 105 will be on hold for an extended period. As a result the customer service agent 125 may select an icon on the second computer 115b that communicates a message informing the opportunity module 315 of the interaction opportunity. Alternatively, if the customer service agent 125 places the customer 105 on hold for what is expected to be a short interval, the customer service agent 125 may not communicate a message to the opportunity module 315 and the opportunity module 315 may not identify 425 the interaction opportunity.

In one embodiment, the opportunity module 315 identifies 425 an interaction opportunity each time the customer 105 is placed on hold unless the customer service agent 125 communicates a message to the opportunity module 315 that the hold is not a suitable interaction opportunity. For example, if the customer service agent 125 expects to place the customer 105 on hold for brief time, the customer service agent 125 may communicate a message to the opportunity module 315 that indicates the hold is not an interaction opportunity.

The presentation module 320 presents 430 a customer interaction to the customer 105 and the method 400 terminates. For example, if the customer 105 reports an imminent hard-drive failure using a computer 200, the presentation module 320 may present 430 a customer interaction using media selected from text, a visual display, and an audio message to provide up-selling information on an external hard-disk drive.

In an alternate embodiment, the presentation module 320 may present 430 a customer interaction that is interactive and uses a three-dimensional avatar to provide up-selling information. For example, if a customer 105 reported an intermittent external speaker problem, the presentation module 320 may present 430 a customer interaction using a three-dimensional avatar promoting a flat panel monitor integrated with speakers for an up-selling opportunity.

In an alternate embodiment, if the customer 105 is communicating using a phone 110, the presentation module 320 may present 430 a customer interaction using an audio message. For example, if the customer 105 reported slow computer processing time, the presentation module 320 may present 430 a customer interaction comprising an audio message selling a high-speed processor.

In one embodiment, the customer interaction provides an opportunity for the customer 105 to make a purchase. For example, an interactive, three-dimensional avatar displayed on a screen may invite the customer 105 to purchase an item by selecting an icon that is also displayed on the screen. Alternatively, an audio message may invite the customer 105 to purchase the item by speaking a word such as “purchase.”

In one embodiment, the presentation module 320 completes the transaction with the customer after the service dialog. For example, if the customer 105 accepts the invitation to purchase an item, the presentation module 320 may communicate a message to the customer service agent 125 at the end of the service dialog that the customer service agent 125 should complete the transaction. Alternatively, the presentation module 320 may transfer the customer 105 to a fulfillment center to complete the transaction after the service dialog ends.

The presentation module 320 may communicate to the customer service agent 125 that the customer service agent 125 should delay resuming the service dialog until the presentation module 320 completes the transaction. In one embodiment, the customer service agent 125 may be unable to resume the service dialog until the transaction is complete. In a certain embodiment, the presentation module 320 may direct the customer service agent to resume the service dialog immediately to complete the transaction.

The method 400 automates up-selling by identifying 415 customer interactions, identifying 425 interaction opportunities, and presenting 430 customer interactions. Thus the method 400 takes advantage of dialog pauses and disclosed customer needs during service dialogs to present an automated customer interaction that may up-sell the customer 105 on needed products and services.

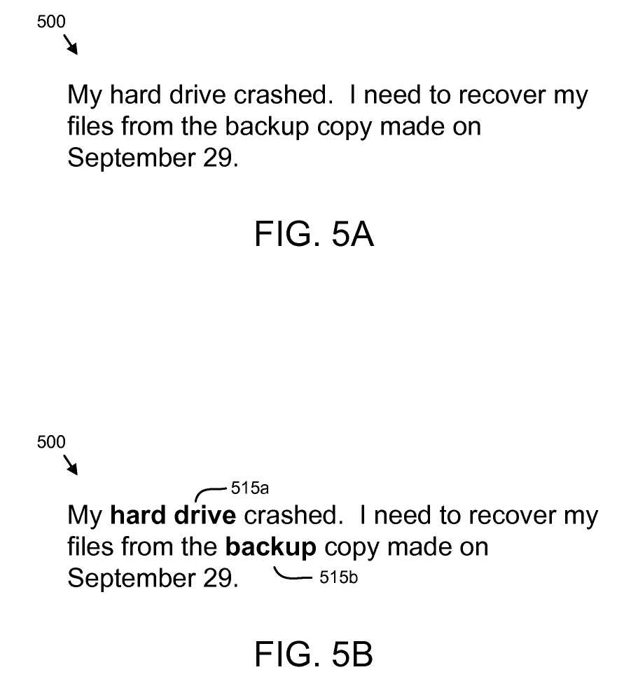

FIGS. 5A and 5B are text representations illustrating one embodiment of service dialog text 500 of the present invention. The text 500 shows the converted service dialog and the identified key words 515a and 515b. The description of the service dialog text 500 refers to elements of FIGS. 1-4, like numbers referring to like elements.

The conversion module 325 converts the service dialog into the service dialog text 500 of FIG. 5A. For example, the customer 105 may report a hard-drive failure and the need to retrieve lost information from a back-up copy. The conversion module 325 converts the service dialog to the service dialog text 500. The search module 305 searches 410 the service dialog text 500 for the key words. In one embodiment, the search module 305 searches 410 using a fuzzy search algorithm for key words. The search module 305 identifies “hard drive” 515a and “backup” 515b as key words that may provide a customer interaction opportunity. The identification module 310 identifies 415 a customer interaction from key words 515.

In an alternate, embodiment the customer 105 may report multiple issues to the customer service agent 125. For example, the customer may report a hard-drive failure, slow computer processing speed, and computer speakers that are working intermittently in the course of the service dialog. The search module 305 searches 410 using a fuzzy search algorithm recognition for key words as to which issue may result in the best opportunity for upselling at a maximum profit to the company.

Continuing the embodiment, the primary reason the customer 105 may contact the customer service agent 125 is to report the hard-drive failure, but the fuzzy logic pattern recognition of the search module for key words may indicate that slow processing speed has the highest level of irritation. The speaker 140a working intermittently may be the next highest irritant. Additionally, fuzzy logic may show the customer 105 as a technical novice. The search module 305 may determine that up-selling a monitor with built in speakers as a simple install providing a higher probability of customer purchase, even though it may be the second highest profit item that could be offered.

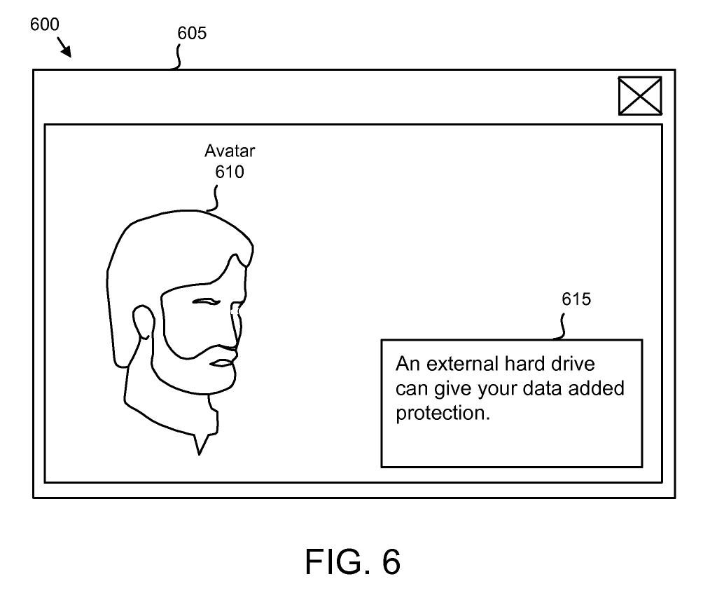

FIG. 6 is a drawing illustrating one embodiment of a customer interaction 600 of the present invention. The presentation 600 shows a computer window 605, a three-dimensional avatar 610, and a text box 615. The description of the presentation 600 refers to elements of FIGS. 1-5, like numbers referring to like elements.

In the shown embodiment, the presentation module 320 presents 430 the customer interaction 600 to the customer 105 using the computer window 605 displayed on a computer monitor, a projection system, or the like. Continuing the above example, the three-dimensional avatar 610 presents to the customer 105 the customer interaction 600 that includes the text box 615 detailing that an external hard-drive can give data additional protection. The customer interaction 600 may provide interactive opportunities for the customer 105 to research product or service options available while waiting for the customer service agent 125.

In one embodiment, the customer may select the avatar 610. For example, the customer 105 may have the option of selecting a computer generated three-dimensional avatar, a photo generated avatar, an existing personal avatar or a personally designed avatar. The presentation module 320 may provide options for the customer 105 to select the avatar of the customer's choice. The customer 105 may select a previously generated avatar or design a computer generated avatar by selecting characteristics including but not limited to gender, ethnicity, personality, voice, hair style/color, body build, and clothing. Alternatively, the customer 105 may select a photo generated avatar from a previously prepared list of photos or select one of the customer's own photos. The customer 105 may select a personal avatar that was previously developed. The presentation module 320 may use the selected avatar 610 for the presentation interaction 430.

FIG. 7 is a drawing illustrating one embodiment of an Instant Messaging application 700 of the present invention. The application 700 includes a window 705, a text dialog screen 710, a connect icon 715, a receive icon 720, and an up-sell icon 725. The description of the application refers to elements of FIGS. 1-5, like numbers referring to like elements.

The customer service agent 125 may employ the application 700 to provide service to the customer 105 using Instant Messaging. The window 705 may be displayed in the computer 115b of the customer service agent 125. The connect icon 725 and receive icon 720 may initiate and accept Instant Messaging dialogs respectively. The dialog screen 710 may display a text-based service dialog between the customer service agent 125, referred to here for illustrative purposes as “Agent 2456” and the customer 105, referred to here for illustrative purposes as “John Doe.”

In one embodiment, the customer service agent 125 uses the up-sell icon 725 to direct the presentation module 320 to present 430 a customer interaction to the customer 105. The customer service agent 125 may employ the up-sell icon 725 while performing a task for the customer 105.

FIG. 8 is a drawing illustrating one embodiment of a VOIP application 800 of the present invention. The application 800 includes a window 805, a call display 810, a call icon 815, an answer icon 820, a hold icon 825, an up-sell icon 830, and a block icon 835. The description of FIG. 8 may refer to elements of FIGS. 1-5, like numbers referring to like elements.

The customer service agent 125 may hold a service dialog with the customer 105 over a VOIP connection through the network 120 and the computers 115 using the application 800. The window 805 may be displayed in the computer 115b of the customer service agent 125. The customer service agent 125 may use the call icon 815 and the answer icon 820 to place and answer VOIP calls respectively. In addition, the customer service agent 125 may place the customer 105 on hold using the hold icon 825.

The call display 810 may communicate the IP address of the customer 105, the company name of the customer 105, and a service contract support level. In one embodiment, the customer service agent 815 uses the up-sell icon 830 to direct the presentation module 320 to present 430 a customer interaction to the customer 105. Alternatively, the customer service agent 125 may use the up-sell icon 830 to enable the presentation module 320 to present 430 the customer interaction when the customer service agent 125 places the customer 105 on hold.

In a certain embodiment, the customer service agent 125 uses the block icon 835 to direct the blocking module 330 to block the customer interaction. For example, if the customer service agent 125 intends to briefly place the customer 105 on hold, the customer service agent 125 may use the block icon 835 to block the start of the customer interaction.

The embodiment of the present invention automates dialog driven up-selling. Additionally, the present invention may educate about future innovations, products, and services.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for automated dialog driven up-selling, the apparatus comprising:
a search module comprising a computer program product and configured to search service dialog text from a service dialog between a customer and a customer service agent for at least one specified key word;
an identification module comprising a computer program product and configured to identify a customer interaction in response to the at least one specified key word;
an opportunity module comprising a computer program product and configured to identify an interaction opportunity, wherein the customer is not interacting with the customer service agent; and
a presentation module comprising a computer program product and configured to present the customer interaction to the customer.

2. The apparatus of claim 1, wherein the service dialog is an audio service dialog and further comprising a conversion module comprising a computer program product and configured to convert the audio service dialog into the service dialog text.

3. The apparatus of claim 1, further comprising a blocking module comprising a computer program product and configured to receive a blocking request and block the customer interaction in response to the blocking request.

4. The apparatus of claim 1, wherein the customer interaction is interactive.

5. The apparatus of claim 4, wherein the customer interaction employs a three-dimensional avatar.

6. The apparatus of claim 4, wherein the presentation module presents the customer interaction using media selected from text, a visual display, and an audio message.

7. A computer program product comprising a computer useable medium having a computer readable program, wherein the computer readable program when executed on a computer causes the computer to:
search service dialog text from a service dialog between a customer and a customer service agent for at least one specified key word;
identify a customer interaction in response to the at least one specified key word;
identify an interaction opportunity, wherein the customer is not interacting with the customer service agent; and
present the customer interaction to the customer.

8. The computer program product of claim 7, wherein the service dialog is an audio service dialog and the computer readable code is further configured to cause the computer to convert the audio service dialog into the service dialog text.

9. The computer program product of claim 8, wherein the audio service dialog employs a Voice Over Internet Protocol.

10. The computer program product of claim 7, wherein the computer readable code is further configured to cause the computer to convert an Instant Messaging dialog into the service dialog text.

11. The computer program product of claim 7, wherein the computer readable code is further configured to cause the computer to receive a blocking request and block the customer interaction in response to the blocking request.

12. The computer program product of claim 7, wherein the customer interaction is interactive.

13. The computer program product of claim 12, wherein the computer readable code is further configured to cause the computer to present the customer interaction using a three-dimensional avatar.

14. The computer program product of claim 12, wherein the computer readable code is further configured to cause the computer to present the customer interaction using media selected from text, a visual display, and an audio message.

15. The computer program product of claim 7, wherein the computer readable code is further configured to cause the computer to search the service dialog text using a fuzzy search algorithm.

16. A system for automated dialog driven up-selling, the system comprising:
a communications medium configured to provide communications between a customer and a customer service agent;
a computer in communication with the communications medium and comprising
a search module comprising a computer program product and configured to search service dialog text from a service dialog between the customer and the customer service agent for at least one specified key word;
an identification module comprising a computer program product and configured to identify a customer interaction in response to the at least one specified key word;
an opportunity module comprising a computer program product and configured to identify an interaction opportunity, wherein the customer is not interacting with the customer service agent;
a presentation module comprising a computer program product and configured to present the customer interaction to a customer; and
a blocking module comprising a computer program product and configured to receive a blocking request and block the customer interaction in response to the blocking request.

17. The system of claim 16, wherein the communications medium employs a Voice Over Internet Protocol.

18. The system of claim 16, wherein the communications medium employs an Instant Messaging protocol.

19. The system of claim 16, wherein the customer interaction is interactive and employs a three-dimensional avatar.

20. A method for deploying computer infrastructure, comprising integrating computer readable code into a computing system, wherein the code in combination with the computing system is capable of performing the following:
converting an audio service dialog between a customer and a customer service agent into service dialog text
searching the service dialog text for at least one specified key word using a fuzzy search algorithm;
identifying a customer interaction in response to the at least one specified key word;
identifying an interaction opportunity, wherein the customer is not interacting with the customer service agent; and
presenting the customer interaction to a customer using an interactive three-dimensional avatar.
